(19) United States
(12) Patent Application Publication
(10) Pub. No.: US 2017/0148247 A1
(43) Pub. Date: May 25, 2017

(54) AUTOMATIC TRANSACTION DEVICE

(71) Applicant: Oki Electric Industry Co., Ltd., Tokyo (JP)

(72) Inventors: Satoru SHIMIZU, Tokyo (JP); Noriyasu KIKUCHI, Tokyo (JP); Hironobu HATAMOTO, Tokyo (JP); Kenichi SHIROTA, Tokyo (JP); Takahiro ODA, Tokyo (JP)

(73) Assignee: Oki Electric Industry Co., Ltd., Tokyo (JP)

(21) Appl. No.: 15/317,766

(22) PCT Filed: Jun. 1, 2015
(86) PCT No.: PCT/JP2015/065820

§ 371 Date: Dec. 9, 2016

(30) Foreign Application Priority Data
Jun. 13, 2014 (JP) 2014-122207

(51) Int. Cl. G07D 11/00; H02J 50/10

(52) U.S. Cl. CPC G07D 11/0009; G07D 11/0012; H02J 50/10

(57) ABSTRACT

An automatic transaction device includes a main body casing and a banknote storage vault. A non-contact electricity transmitter and an equipment wireless communications unit that communicates information by first electromagnetic waves are mounted inside the main body casing. The banknote storage vault is stowable inside the main body casing and removable to outside the main body casing, and stores banknotes. The banknote storage vault includes thereinside a non-contact electricity receiver that receives electricity from the non-contact electricity transmitter and a storage vault wireless communications unit that is supplied with electricity by the non-contact electricity receiver and is for communicating information with the equipment wireless communications unit. In a stowed state in which the banknote storage vault is stowed inside the main body casing, the non-contact electricity transmitter and the non-contact electricity receiver are in a proximate state.

### TECHNICAL FIELD

The present disclosure relates to an automatic transaction device that may transmit power supply electricity to a banknote deposit and withdrawal section without contact.

### BACKGROUND ART

In fields of industrial equipment such as information and communication technology (ICT) equipment and the like, research and development is progressing into intra-apparatus wireless, to replace electric wiring with wireless between parts within equipment. For example, an automatic transaction device such as an automated teller machine (ATM), a ticket-selling machine or the like is equipped with many sensors for conveying mediums and with units (including a control device) that function as base units (access points) that receive electromagnetic waves from the sensors (terminals). Intra-apparatus wireless reduces connectors, harnesses and the like between these parts. Therefore, a reduction in assembly steps, a reduction in weight of the automatic transaction device and suchlike may be achieved; there are also advantages of improvements in maintenance, ease of use and the like.

Various units provided in an ATM (in particular, a banknote storage vault of a banknote deposit and withdrawal section) have electronic circuits thereinside, such as sensors that detect quantities of banknotes present, conveyance motors that operate to take in and feed out banknotes, and so forth. In general, signals communicating with these circuits and a supply of electricity are passed through a jack connector connected to the banknote deposit and withdrawal section. For the banknote storage vault, it is often the case that the connector is connected at a floor face of the banknote storage vault so as to take advantage of the weight of the vault for reliable connection. Thus, the banknote storage vault is electrically connected to an ATM main body via the connector.

The banknote storage vault is often taken outside the ATM main body for refilling and collection of cash and the like. Therefore, the jack connector needs to be easy to connect and disconnect and needs to conduct electricity reliably. The technology described in Japanese Patent No. 3,462,715 transmits signals using optical communications and transmits power supply electricity without using a jack connector. In the technology described in Japanese Patent No. 3,462,715, signals from a light emitting circuit incorporated in a banknote deposit and withdrawal section are received by a light detection circuit at an ATM main body. In this case, electromagnetic coupling is used as a technique for supplying electricity to the banknote deposit and withdrawal section from the ATM main body. Thus, the technology described in Japanese Patent No. 3,462,715 supplies power supply electricity produced at the ATM main body to the banknote deposit and withdrawal section. The banknote deposit and withdrawal section applies a power supply voltage corresponding to light emission amounts to a light detection circuit. Thus, a judgment threshold of the light detection circuit at the banknote deposit and withdrawal section can be freely adjusted. Because the banknote deposit and withdrawal section is supplied with power supply electricity by electromagnetic coupling, a connector with a mechanical contact may be rendered unnecessary. Meanwhile, Japanese Patent Application Laid-Open (JP-A) No. 2008-33423 recites a technology that shortens the time taken to identify a required banknote cassette in a cassette storage vault that stores multiple banknote cassettes.

However, a characteristic of wireless communications is that electromagnetic waves from a particular base unit and electromagnetic waves produced by outside wireless communications equipment are likely to interfere if using the same channel (the same frequency band). Thus, intra-equipment wireless is susceptible to effects from, for example, electromagnetic waves (interference) produced by external wireless communications equipment.

### SUMMARY OF INVENTION

### Technical Problem

The technology described in Japanese Patent No. 3,462,715 is advantageous if variations in light detection amounts are caused by variations in light emission amounts. However, optical communications are weakened by dusts. The technology described in Japanese Patent No. 3,462,715 may not be able to respond if dusts adhere between a light emitting element and a light detection element and reduces light detection amounts at the light detection element. For optical communications, apertures that allow light to pass must be formed in casings both at an ATM and at a banknote deposit and withdrawal section, or a light transmission member that transmits light must be employed in casings both at an ATM and at a banknote deposit and withdrawal section. When a light transmission member is used, a casing is a body molded by two-color molding.

As the number of times a jack connector is connected and disconnected increases, contact failures may occur and electricity may not be conducted. Because a banknote deposit and withdrawal section of an ATM is often disposed at a lower portion of the ATM main body, a disposition region of the ATM in which the bank deposit and withdrawal section is located is susceptible to accumulations of dusts. These dusts can cause a contact failure of a jack connector. Thus, if a mechanical connector is used to assure electrical conduction, functioning of the banknote deposit and withdrawal section is vulnerable to these problems.

The technology described in Japanese Patent No. 3,462,715 may eliminate contact failures of a connector. However, because the technique that is used is optical communications, dusts may accumulate and communication quality may deteriorate. Therefore, the technology described in Japanese Patent No. 3,462,715 is not a complete solution and cannot deal with light detection variations in optical communications that are caused by dusts.

The present disclosure provides an automatic transaction device in which power supply electricity may be transmitted to a removable banknote storage vault without contact.

### Solution to Problem

A first aspect of the present disclosure is an automatic transaction device including a main body casing and a banknote storage vault that is provided to be removable to outside the main body casing and that stores banknotes. A non-contact electricity transmitter (for example, a coil 4b) and an equipment wireless communications unit that communicates information by electromagnetic waves are mounted inside the main body casing. The banknote storage vault includes thereinside: a non-contact electricity receiver (for example, a coil 4a) that receives electricity from the non-contact electricity transmitter; and a storage vault wireless communications unit that is supplied with electricity by the non-contact electricity receiver and that communicates information with the equipment wireless communications unit. In a stowed state in which the banknote storage vault is stowed inside the main body casing, the non-contact electricity transmitter and the non-contact electricity receiver are in a proximate state.

When in the stowed state, electricity is transmitted between the non-contact electricity transmitter and the non-contact electricity receiver, and data is transmitted between the storage vault wireless communications unit and the equipment wireless communications unit using the transmitted power supply electricity. The transmitted power supply electricity is also used to convey banknotes inside the banknote storage vault. Because the non-contact electricity transmitter and the non-contact electricity receiver must transmit the electric power required to drive a conveyance motor (tens of watts), an electromagnetic induction system employing coils is favorable. In a removed state in which the banknote storage vault is removed to outside the main body casing, it is preferable that the non-contact electricity transmitter and the non-contact electricity receiver are in a separated state in which the non-contact electricity transmitter and the non-contact electricity receiver are separated in a removal direction. Accordingly, because a power supply cable and a communications cable connecting between the banknote storage vault and the main body casing of the automatic transaction device are unnecessary, there is no need for bending of cables for transfers between the stowed state and the removed state.

A second aspect of the present disclosure is an automatic transaction device including a main body casing in which an aperture portion is provided and a unit (for example, a banknote storage vault 36, a card unit 23 or a receipt processing unit 22) that is provided inside the main body casing. A non-contact electricity transmitter that transmits electricity by electromagnetic induction and an equipment wireless communications unit that communicates information by electromagnetic waves are mounted inside the main body casing. The unit includes thereinside: a non-contact electricity receiver that receives electricity from the non-contact electricity transmitter; and a unit wireless communications section that is supplied with electricity by the non-contact electricity receiver and that communicates with the equipment wireless communications unit. A casing of the unit, at least between a coil of the non-contact electricity transmitter and a coil of the non-contact electricity receiver, is formed of resin that is plated with metal or vapor-deposited with metal.

Interference waves (electromagnetic waves) of the same frequency as a communication frequency (for example, the 2.4 GHz band) of plural communication devices disposed in the unit (for example, a data carrier and an access point) intrude into the unit through apertures in the main body casing (including a fan aperture, a vent aperture and the like) and an aperture of the casing of the unit between an antenna of the equipment wireless communications unit and an antenna of the unit wireless communications unit. However, because the resin casing is plated with metal or vapor-deposited with metal between the coil of the non-contact electricity transmitter and the coil of the non-contact electricity receiver, magnetic fields and electromagnetic waves at tens of kHz are transmitted but interference waves in the 2.4 GHz band are reflected. Given that the coils are larger than the antennas of the wireless communications units, effects from interference waves intruding through the aperture portion between the two antennas are slight.

### Advantageous Effects of Invention

According to the present disclosure, power supply electricity may be transmitted without contact to a removable banknote storage vault. Furthermore, the effects of interference waves may be reduced by the use of a resin casing that is plated with metal or vapor-deposited with metal between a coil of a non-contact electricity transmitter and a coil of a non-contact electricity receiver.

### BRIEF DESCRIPTION OF DRAWINGS

FIG. 1 is a perspective view of an automatic transaction device according to a first embodiment of the present disclosure.

FIG. 2 is a schematic diagram of a banknote deposit and withdrawal section according to the first embodiment of the present disclosure.

FIG. 3 is a diagram showing a state in which a cassette loading frame is removed from the banknote deposit and withdrawal section.

FIG. 4 is a descriptive diagram of electricity transmission and information communications conducted between a main body of the automatic transaction device and a banknote storage vault.

FIG. 5 is aother descriptive diagram of electricity transmission and information communications conducted between the main body of the automatic transaction device and a banknote storage vault.

FIG. 6 is a descriptive diagram of electricity transmission and information communications conducted between the main body of the automatic transaction device and banknote storage vaults.

FIG. 7 is a structural diagram of an automatic transaction device according to a third embodiment of the present disclosure.

FIG. 8 is a schematic diagram of a banknote deposit and withdrawal section according to a fourth embodiment of the present disclosure.

FIG. 9 is a schematic diagram of an automatic transaction device according to a fifth embodiment of the present disclosure.

### DESCRIPTION OF EMBODIMENTS

Below, embodiments of the present disclosure (hereinafter referred to as the present embodiments) are described in detail with reference to the drawings. The drawings are schematically illustrated only to the extent required to enable proper understanding of the present disclosure. Common structural elements and similar structural elements in the drawings are assigned the same reference symbols and duplicative descriptions of such are not given.

### First Exemplary Embodiment

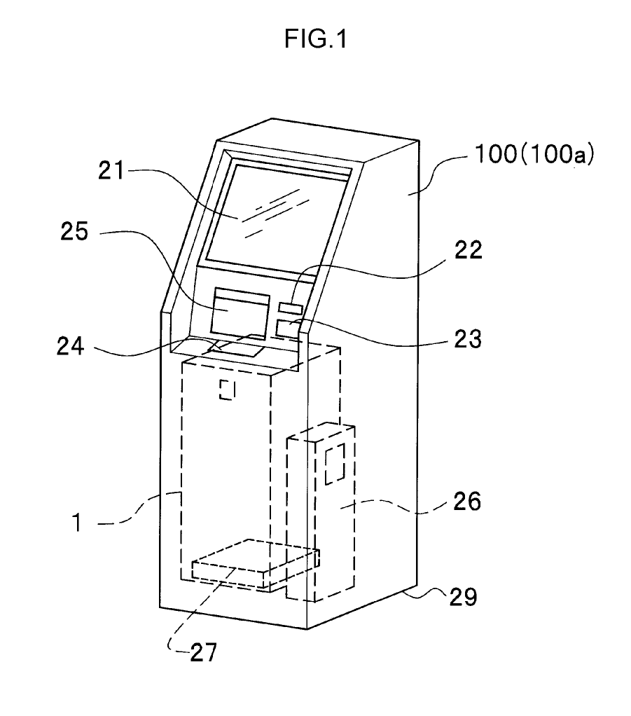

FIG. 1 is a perspective view of an automatic transaction device according to a first embodiment of the present disclosure.

In FIG. 1, an automatic transaction device 100 (100a) is an ATM that is disposed in a financial institution, a retail institution or the like. The automatic transaction device 100 is equipped with a banknote deposit and withdrawal section 1, a customer operation and display section 21, the receipt unit 22, the card unit 23, a numberpad section 24, an external shutter 25 and a control device 26. These sections are accommodated inside a main body casing 29.

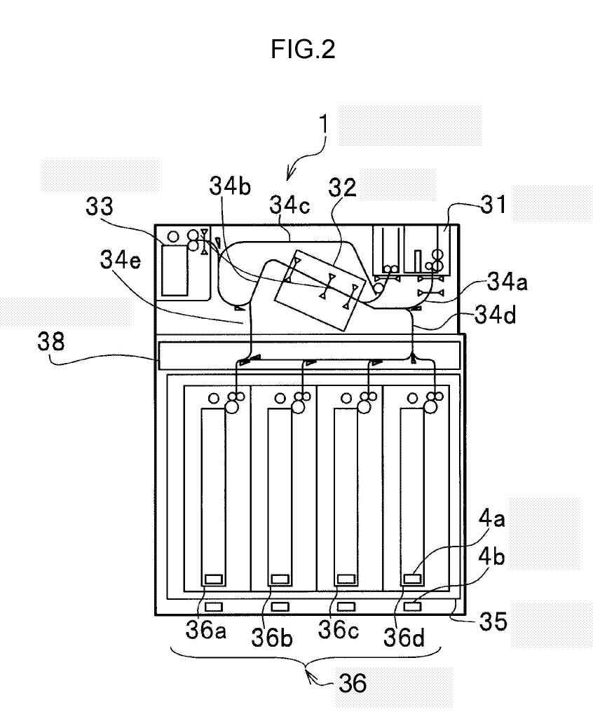

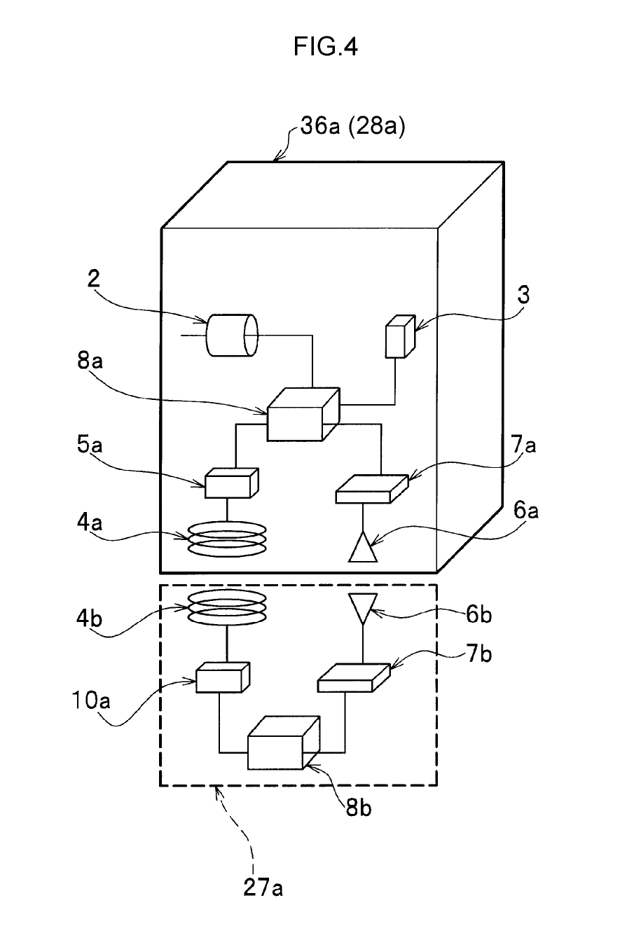

The banknote deposit and withdrawal section 1 is a cassette mechanism section that verifies banknotes (paper sheets), which are mediums that are inserted at a customer service section (a banknote insertion aperture) 31 (see FIG. 2), that counts numbers of respective denominations, and that stores banknotes of the different denominations in plural banknote storage vaults (banknote cassettes) 36a, 36b, 36c and 36d (see FIG. 2). A communications device with electricity transmission function 27 is mounted inside the banknote deposit and withdrawal section 1 and a communications device with electricity reception function 28 is mounted inside each of the banknote storage vaults 36a, 36b, 36c and 36d (FIG. 4). The present embodiment presents a structure in which the communications device with electricity transmission function 27 and the communications device with electricity reception function 28 are not in contact but are electrically connected. Power supply electricity is supplied from the communications device with electricity transmission function 27 to the communications device with electricity reception function 28 and data is communicated by wireless between the communications device with electricity transmission function 27 and the communications device with electricity reception function 28.

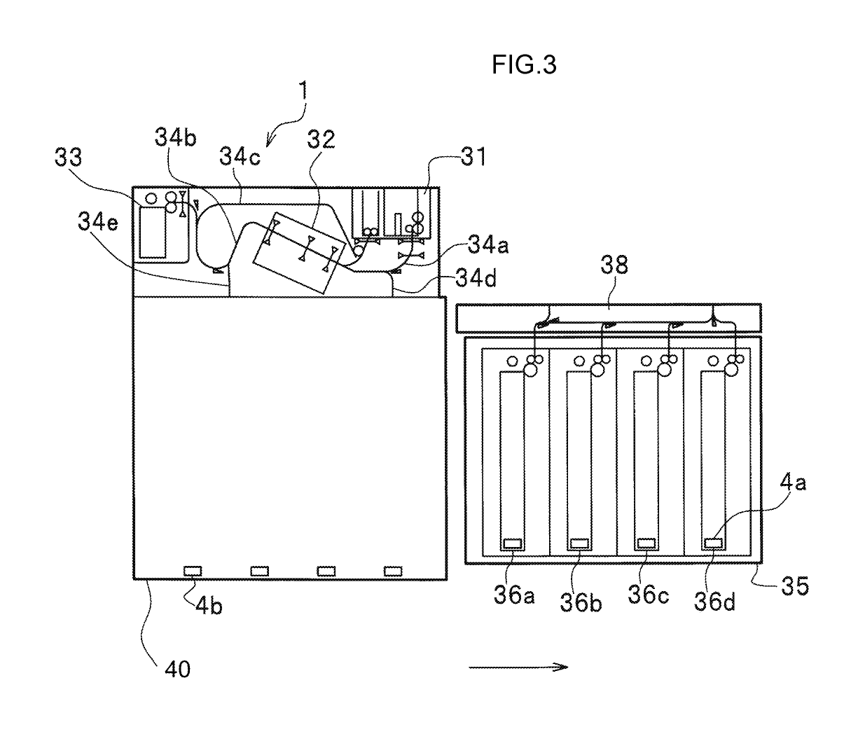

FIG. 2 is a schematic diagram of a banknote deposit and withdrawal section according to the first embodiment of the present disclosure, and FIG. 3 is a diagram showing a state in which a cassette loading frame is removed from the banknote deposit and withdrawal section.

The banknote deposit and withdrawal section 1 is provided with the customer service section 31, a verification section 32, a temporary retention section 33, conveyance paths 34 (34a, 34b, 34c, 34d and 34e), a cassette loading frame 35, and the banknote storage vaults (banknote cassettes) 36a, 36b, 36c and 36d. The banknote storage vaults 36a, 36b, 36c and 36d are loaded into an upper portion of the cassette loading frame 35, and a conveyance path frame 38 is disposed at upper portions of the banknote storage vaults (banknote cassettes) 36a, 36b, 36c and 36d.

In the banknote deposit and withdrawal section 1, four coils 4b that serve as non-contact electricity transmitter are disposed below the cassette loading frame 35, and coils 4a that serve as non-contact electricity receivers are disposed at lower portions of the banknote storage vaults 36a, 36b, 36c and 36d. The coils 4a and coils 4b oppose and are separated from one another. The cassette loading frame 35 is a metal frame on which the banknote storage vaults 36a, 36b, 36c and 36d are loaded. In order to prevent reflections of magnetic fields and electromagnetic waves, aperture portions are formed in the cassette loading frame 35 between the coils 4a and the coils 4b, and between antennas 6a and 6b (see FIG. 4).

As shown in FIG. 3, the banknote deposit and withdrawal section 1 is configured such that an operator may pull the cassette loading frame 35 out from a banknote deposit and withdrawal section frame 40 in a front-rear direction, open up the conveyance path frame 38 and, after lifting the banknote storage vaults 36a, 36b, 36c and 36d upward, load banknotes into the banknote storage vaults 36a, 36b, 36c and 36d and recover banknotes from the banknote storage vaults 36a, 36b, 36c and 36d. In a removed state in which the cassette loading frame 35 is pulled out, the coils 4b remain inside the banknote deposit and withdrawal section 1. Thus, the coils 4a and 4b are in a separated state, being separated from one another. In contrast, in a stowed state shown in FIG. 2, the coils 4a and 4b are close to one another and are in a proximate state.

Protrusions and recesses that fit with one another are formed along a vertical direction in the cassette loading frame 35 and the banknote storage vaults 36a, 36b, 36c and 36d of the banknote deposit and withdrawal section 1, and the banknote storage vaults 36a, 36b, 36c and 36d may be slid substantially in the vertical direction. Protrusions and recesses that fit with one another in the stowed state (see FIG. 2) are formed along a horizontal direction in the cassette loading frame 35 and the banknote deposit and withdrawal section frame 40, and the cassette loading frame 35 may be slid in the removal direction. Thus, an operator may pull out the cassette loading frame 35 in the front-rear direction from the banknote deposit and withdrawal section frame 40 (from a main body frame that structures a main body casing of the automatic transaction device 100a) and lift the banknote storage vaults 36a, 36b, 36c and 36d upward. The verification section 32 is equipped with a read-only memory (ROM) in which a program is stored, a random access memory (RAM) and a central processing unit (CPU; a control section).

The customer service section 31 is a portion disposed in a vicinity of the external shutter 25 (see FIG. 1) at which users insert banknotes and take out banknotes. The verification section 32 is a portion that verifies banknotes inserted into the customer service section 31 and counts numbers of respective denominations. The conveyance paths 34 (34a, 34b, 34c, 34d and 34e) convey banknotes inserted into the customer service section 31 through the verification section 32 to the temporary retention section 33, and convey the respective denominations from the temporary retention section 33 through the verification section 32 to the banknote storage vaults 36a, 36b, 36c and 36d. The conveyance paths 34 also convey banknotes from the banknote storage vaults 36a, 36b, 36c and 36d through the verification section 32 to the customer service section 31. Both the conveyance paths 34 and the banknote storage vaults 36a, 36b, 36c and 36d are equipped with electric motors (conveyance motors) that convey the banknotes. The banknote storage vaults 36a, 36b, 36c and 36d are provided with the coils 4a that receive power supply electricity without contact, antennas 6a for data communications (see FIG. 4).

The banknote deposit and withdrawal section 1 is provided with a communications device with electricity transmission function 27a (see FIG. 1 and FIG. 4), incorporating the coils 4b, below all of the banknote storage vaults 36a, 36b, 36c and 36d and below the cassette loading frame 35. In accordance with control by the control device 26, the communications device with electricity transmission function 27a supplies power supply electricity to the banknote storage vaults 36a, 36b, 36c and 36d of the banknote deposit and withdrawal section 1 and exchanges control data with the banknote storage vaults 36a, 36b, 36c and 36d.

The customer operation and display section 21 (see FIG. 1) is a touch panel-type liquid crystal display (LCD) that displays transaction screens. The receipt processing unit 22 is a printer that prints transaction details onto paper slips. The card unit 23 is a unit that reads information stored on magnetic tapes, IC (Integrated circuit) and the like that are attached to financial cards and writes transaction date and the like to the IC.

The control device 26 is constituted by a factory computer (FC), loads an operation system (OS), transaction programs and the like that are stored in a nonvolatile memory section such as a hard disk drive (HDD) or the like into RAM, and controls respective sections through execution of the OS and transaction programs by the CPU.

FIG. 4 is a descriptive diagram of electricity transmission and data communications performed between the main body of the ATM and the banknote storage vaults.

The banknote storage vault 36a contains a motor 2, a sensor 3 and the like inside a casing; these are connected to a control circuit 8 (8a). The banknote storage vaults 36b, 36c and 36d have similar structures to the banknote storage vault 36a although the denominations of the banknotes stored therein are different, so are not described here.

A coil 4 (4a) and antenna 6 (6a) are disposed at a floor face of the casing of the banknote storage vault 36a. The coil 4a is connected with the control circuit 8 (8a) via an electricity reception circuit 5 (5a). The antenna 6 (6a) is connected with the control circuit 8 (8a) via a wireless device 7 (7a). The coils 4a and 4b are annular coils and are separated from one another but oppose one another coaxially, to raise the coupling coefficient.

In the state in which the cassette loading frame 35 is removed to outside the banknote deposit and withdrawal section 1 (see FIG. 3), the two coils 4a and 4b are in the separated state, being separated in the removal direction. In the stowed state in which the cassette loading frame 35 is stowed inside the banknote deposit and withdrawal section 1 (see FIG. 2), the coils 4a and 4b are in the proximate state, being close to one another. The wireless device 7a implements data communications in the 2.4 GHz band that is widely used in wireless LANs.

A casing floor face of the banknote storage vault 36a is formed by a molded item through which electromagnetic waves pass easily (for example, a resin or glass). The casing floor face (particularly portions that are in contact with or close to the cassette loading frame 35) need not have connectors or other protrusions. However, it is preferable to provide depressions, marks or the like for positioning of the banknote storage vault 36a. The banknote storage vault 36a contains motors, actuators and the like, and various sensors are mounted in the banknote storage vault 36a. In FIG. 4 these are summarily depicted as the motor 2 and the sensor 3.

The communications device with electricity transmission function 27a is provided at a lower portion of the main body casing 29 of the automatic transaction device 100a. The communications device with electricity transmission function 27a includes the coil 4b, an electricity transmission circuit 10 (10a), the antenna 6b, a wireless device 7b and a control circuit 8b. In the stowed state in which the cassette loading frame 35 is stowed inside the banknote deposit and withdrawal section 1, the coil 4a and the coil 4b oppose one another and are in the proximate state, and the antenna 6a and the antenna 6b oppose one another and are in a proximate state.

### Description of Operations

The coil 4b is supplied with high-frequency electric power at several tens of kHz from the electricity transmission circuit 10a. The coil 4a of the banknote storage vault 36a and the coil 4b of the communications device with electricity transmission function 27a oppose and are close to one another. A molded item disposed between the coil 4a and the coil 4b (specifically the casing floor face of the banknote storage vault 36) employs a material through which electromagnetic waves (electric fields and magnetic fields) pass easily. Because of these conditions, induced electricity is generated by electromagnetic induction. This induced electricity (an AC voltage) is detected and rectified by the electricity reception circuit 5a. The rectified DC electricity is supplied through the control circuit 8a to various circuits, the motor 2 and the sensor 3. Thus, DC electricity supplied to the motor 2, the sensor 3 and the like is reduced compared to the high-frequency electric power received by the coil 4b.

Exchanges of data between the banknote storage vault 36a and the communications device with electricity transmission function 27a pass through the wireless devices 7a and 7b and the antennas 6a and 6b. Communication information transmitted from the communications device with electricity transmission function 27a includes control signals for the motor 2 in the banknote storage vault 36a and the like. Communication information transmitted from the banknote storage vault 36a includes position information of a stage controlled by a stage motor, sensor information relating to accumulated amounts of banknotes and the like. The antennas 6a and 6b oppose and are disposed close to one another, similarly to the coils 4a and 4b. However, because a wavelength of electromagnetic waves exchanged between the antennas 6a and 6b is short (at 2.4 GHz, a wavelength of 12.5 cm), the antennas are smaller in size than the coils 4a and 4b. Therefore, the antennas 6a and 6b have a degree of freedom of location and may be disposed at arbitrary positions in the banknote storage vault 36a and the main body casing 29 of the automatic transaction device 100 (FIG. 1) in accordance with characteristics of propagation of the electromagnetic waves.

Now the electromagnetic induction and electromagnetic waves (plane waves) are described. The coil 4b is supplied with high-frequency electric power and emits electromagnetic waves. Because the frequency is low at several tens of kHz, magnetic fields are dominant over electric fields near to the coil 4b and induced electricity is produced by electromagnetic induction at the coil 4a. In contrast, because the antenna 6b will often be in a dipole shape rather than a ring shape, electric fields are dominant near to the antenna 6b. Meanwhile, because the electromagnetic waves of the antenna 6b are high in frequency, the strengths of spherical wave components, at which electric field intensity and magnetic field strength are inversely proportional to distance, are large, and plane waves are formed at further distances. In the 2.4 GHz band, the transition from near field to far field is at a distance r that equals λ/2 π (which is around 2 cm. That is, electricity transmission by electromagnetic induction refers to electricity transmission in which magnetic fields are dominant over electric fields around near fields. Meanwhile, electromagnetic waves communicating information in the 2.4 GHz band include spherical wave components, and are close to plane waves.

### Effects

Thus, connectors, cables and the like between the banknote deposit and withdrawal section frame 40 of the automatic transaction device 100a (the main body frame of the automatic transaction device 100a) and the banknote storage vault 36a are not necessary. Consequently, contact failures caused by changes over time, dusts and the like, which are a problem for jack connectors, do not occur. In the automatic transaction device 100a, because it is not necessary to dispose a connector at the main body casing 29 in which the cassette loading frame 35 is disposed, the corresponding region may be formed by a planar molded item. Therefore, cleaning of the main body casing of the automatic transaction device 100a is easier, and quality not just of the region of connection with the banknote deposit and withdrawal section 1 but of the whole automatic transaction device 100a may be improved.

### Variant Example of the First Embodiment

In the first embodiment, power supply electricity is transmitted from the communications device with electricity transmission function 27a of the automatic transaction device 100a to the banknote storage vault 36a (the communications device with electricity reception function 28a) by electromagnetic induction, but an alternative method such as magnetic resonance, electromagnetic waves or electric field coupling can be employed. In such a case, the coils in FIG. 4 are replaced with components appropriate for the respective method. Further, electricity transmission by electromagnetic induction is not driven simply by driving switching of the coil 4b (see FIG. 4); in a resonant state in which capacitors are connected to the coils (in parallel or in series), switching may be driven and a capacitor may be connected to the coil 4a to cause a resonance current to flow.

### Second Embodiment

In the first embodiment, electricity is transmitted using the coils 4a and 4b and data is transferred using the antennas 6a and 6b. In the second embodiment, both electricity transmission and data transfers are implemented using single antennas.

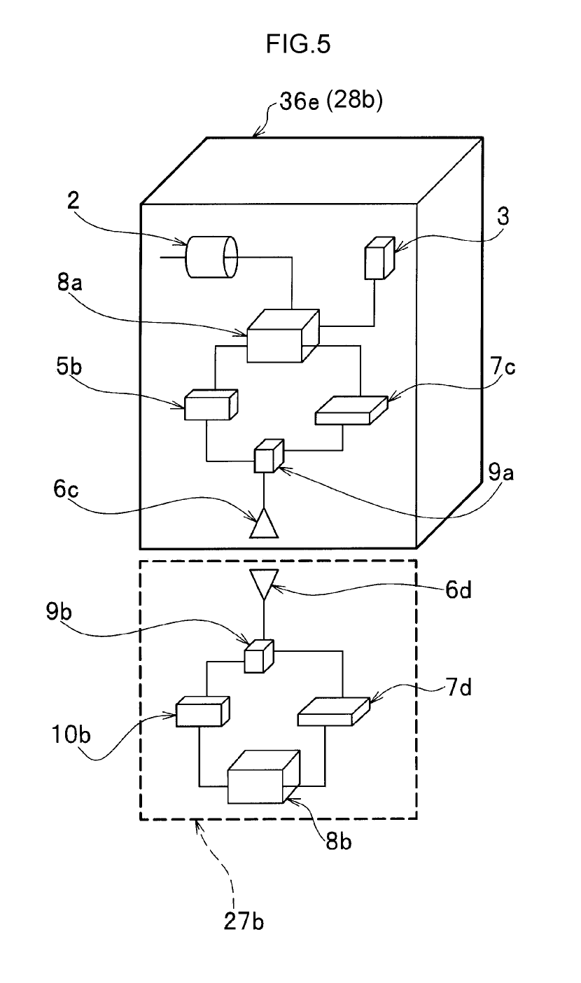

The banknote storage vault 36e shown in FIG. 5 includes the motor 2, the sensor 3, the electricity reception circuit 5b, a wireless device 7c, the control circuit 8a and so forth. Functions thereof are similar to the first embodiment. However, with regard to the motor 2 that conveys banknotes, it is understood that the motor is not equipped or is an actuator with low power consumption. This is because a conveyance motor that conveys banknotes requires a power output (electricity consumption) of tens of watts, but a transmission efficiency of electromagnetic waves using antennas is poor. While the transmission of tens of watts using antennas is technically possible, it is not an appropriate system in practice.

A combiner 9a combines and divides signals of the electricity reception circuit 5b and the wireless device 7c. The combiner 9a is connected to an antenna 6c. In a communications device with electricity transmission function 27b at the automatic transaction device, the electricity transmission circuit 10b, a wireless device 7d and the control circuit 8b are connected with an antenna 6d via a combiner 9b.

In the second embodiment, both electricity transmission and data transfers are performed using the pair of antennas 6c and 6d. For electricity transmission, the electricity transmission circuit 10b generates high-frequency electric power. The generated high-frequency electric power is supplied through the combiner 9a to the antenna 6c and is emitted from the antenna 6c as radiated electricity. The radiated electricity is received by the antenna 6d and is passed through the combiner 9b to the electricity reception circuit 5b. Thus, electricity is transferred without contact. The electricity reception circuit 5b detects and rectifies the high-frequency electric power and supplies rectified DC electricity to the control circuit 8a. That is, the electricity transmission is unidirectional from the ATM main body to the banknote deposit and withdrawal section. If there is no electricity storage function at the banknote deposit and withdrawal section 1, the electricity transmission must be performed continuously without interruption.

Data transfers are the same as in the first embodiment except for passing through the combiners 9a and 9b. That is, data transfers are implemented as bidirectional communications and are performed at timings designated by the control circuits 8a and 8b. Because both electricity transmission and data transfers are conducted by single antennas, an electricity transmission frequency and a data transfer carrier frequency must be well separated and proper isolation therebetween must be assured by filtering within the combiners 9a and 9b. Lengths of the antennas 6c and 6d must be in accord with integer multiples of λ/2 of both the electricity transmission driving frequency and the data transfer carrier frequency, so as to enable resonance.

In the second embodiment, a single antenna may be used for electricity transmission and data transfers. Therefore, an antenna footprint may be reduced. There is a further advantage in that, because a transmission method based on plane waves (electromagnetic waves) is used rather than electromagnetic induction for the electricity transmission, a deterioration in properties if an antenna is mispositioned is small. As described above, the motor 2 must be chosen in accordance with the electric power that can be transmitted.

The banknote storage vaults 36a and 36b of the first embodiment may each be provided with the motor 2 and the other banknote storage vaults 36c and 36d may be not provided with the motor 2. In this case, the banknote storage vault 36e according to the second embodiment may be employed as the other banknote storage vaults 36d and 36e; electricity transmission and data transfers for the sensors 3 thereof may be implemented using only the antennas 6c and 6d rather than the coils 4a and 4b (FIG. 4).

### Third Embodiment

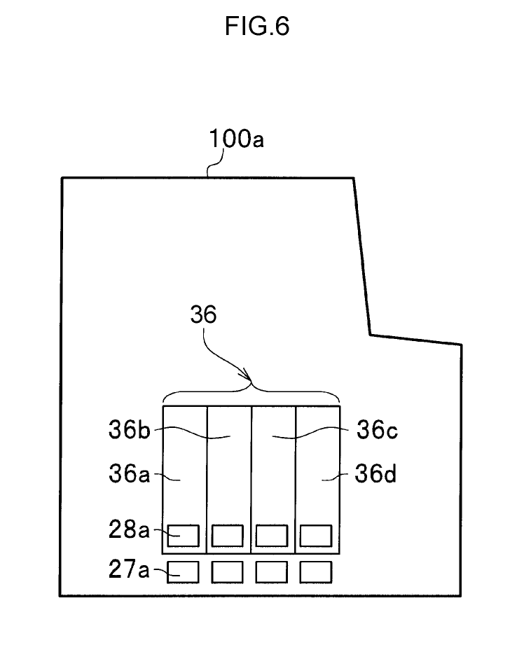

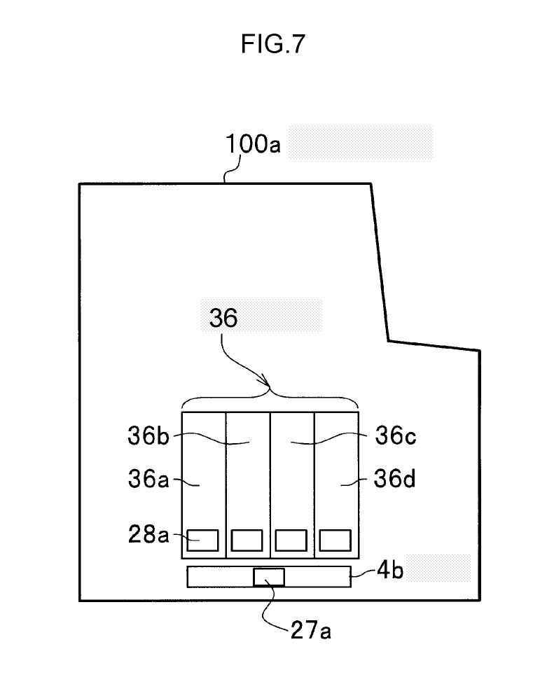

In the first embodiment and the second embodiment, as shown in FIG. 6, the banknote storage vaults 36a, 36b, 36c and 36d and the communications device with electricity transmission function 27 are configured so as to form pairs. Alternatively, as shown in FIG. 7, a structure is possible in which the plural banknote storage vaults 36a, 36b, 36c and 36d are supplied with electricity from a single coil 4b.

FIG. 7 is a structural view of an automatic transaction device according to a third embodiment of the present disclosure. FIG. 7 shows a mode in which plural banknote storage vaults receive electricity supplies from a single electricity transmission circuit. In the first embodiment (FIG. 4), electricity is transmitted by electromagnetic induction using the coils 4a and 4b, and data is transferred by electromagnetic waves using the antennas 6a and 6b. The third embodiment differs in that the coil 4b of the communications device with electricity transmission function 27a is disposed so as to surround all the four coils 4a of the four banknote storage vaults 36a, 36b, 36c and 36d. That is, the coil 4b has a shape that encircles floor faces of the four banknote storage vaults 36a, 36b, 36c and 36d in a substantially rectangular shape. As a result, electricity may be transmitted to the four coils 4a (FIG. 4) using the single coil 4b.

The circuit (the communications device with electricity transmission function 27) that supplies electricity and communicates data from the automatic transaction device 100a is disposed below the casings of the banknote deposit and withdrawal section 1 (the banknote storage vaults 36). However, this circuit may be at side faces of or above the casings of the banknote storage vaults 36.

### Fourth Embodiment

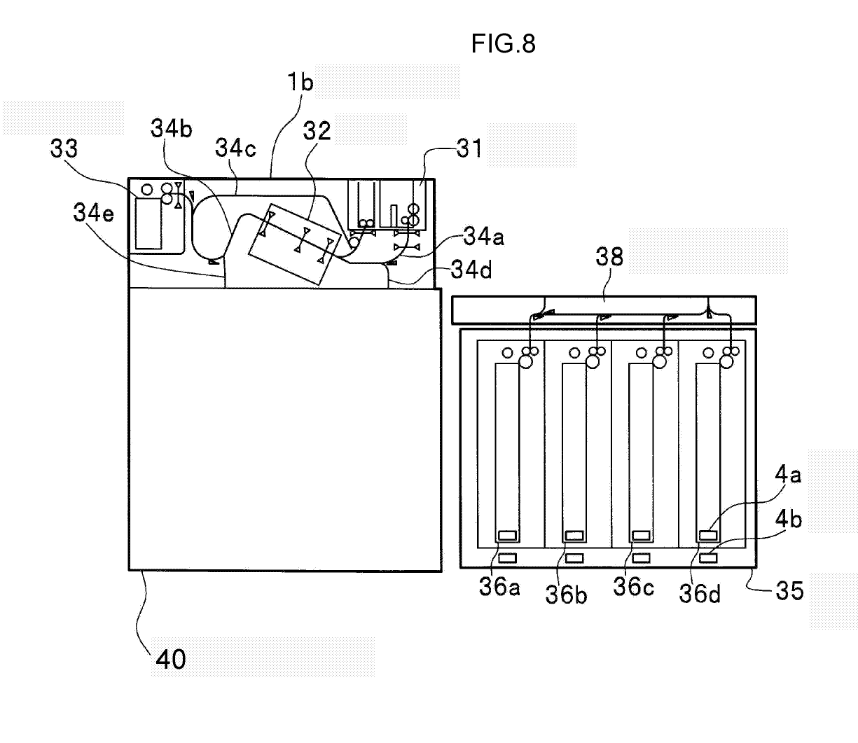

FIG. 8 is a schematic diagram of a banknote deposit and withdrawal section according to a fourth embodiment of the present disclosure. In the banknote deposit and withdrawal section 1 according to the first embodiment (FIG. 3), the coil 4b of the communications device with electricity transmission function 27a is disposed inside the banknote deposit and withdrawal section frame 40 (the main body casing of the automatic transaction device 100a), but the coil 4b may be disposed at the floor face of the cassette loading frame 35.

That is, in a banknote deposit and withdrawal section lb according to the present embodiment, plural pairs of the communications device with electricity transmission function 27a and the communications device with electricity reception function 28a are pulled out by the cassette loading frame 35 being pulled out. The coil 4b of each communications device with electricity transmission function 27a and the coil 4a of the corresponding communications device with electricity reception function 28a are in the proximate state both in the stowed state in which the banknote storage vault 36 is stowed in the banknote deposit and withdrawal section frame 40 and in the removed state in which the cassette loading frame 35 is pulled out from the banknote deposit and withdrawal section frame 40. In the banknote deposit and withdrawal section 1b, the communications device with electricity transmission function 27a and the ATM main body (for example, the control device 26 (FIG. 1)) are connected by a power supply cable, and the power supply cable is bent in accordance with pulling out of the cassette loading frame 35.

The communications device with electricity transmission function 27a and ATM main body need not be connected by a power supply cable but may transmit electricity by coils. For example, in the banknote deposit and withdrawal section 1b, coils are disposed at a rear end of the banknote deposit and withdrawal section frame 40 (a corresponding portion of the frame of the automatic transaction device 100a) and a rear end of the cassette loading frame 35. In the removed state in which the cassette loading frame 35 is pulled out, the coils are in a separated state, being separated in the removal direction, and when the cassette loading frame 35 is stowed in the banknote deposit and withdrawal section frame 40, the coils are in a proximate state.

### Fifth Embodiment

In the first to fourth embodiments, descriptions are given assuming that the main body casing 29 of the automatic transaction device 100a implements shielding and that electromagnetic waves used for data communications are not affected by interference waves from outside (for example, electromagnetic waves in the 2.4 GHz band that are often used in wireless LANs). However, the main body casing 29 of the automatic transaction device 100a is provided with aperture portions such as a fan, an air intake opening and the like, and it is easy for interference waves to intrude from outside. In particular, the coils 4 used for electricity transmission (see FIG. 4) have larger areas than the antennas 6 used for data communications and it is easy for interference waves to intrude inside the banknote storage vaults 36 from outside.

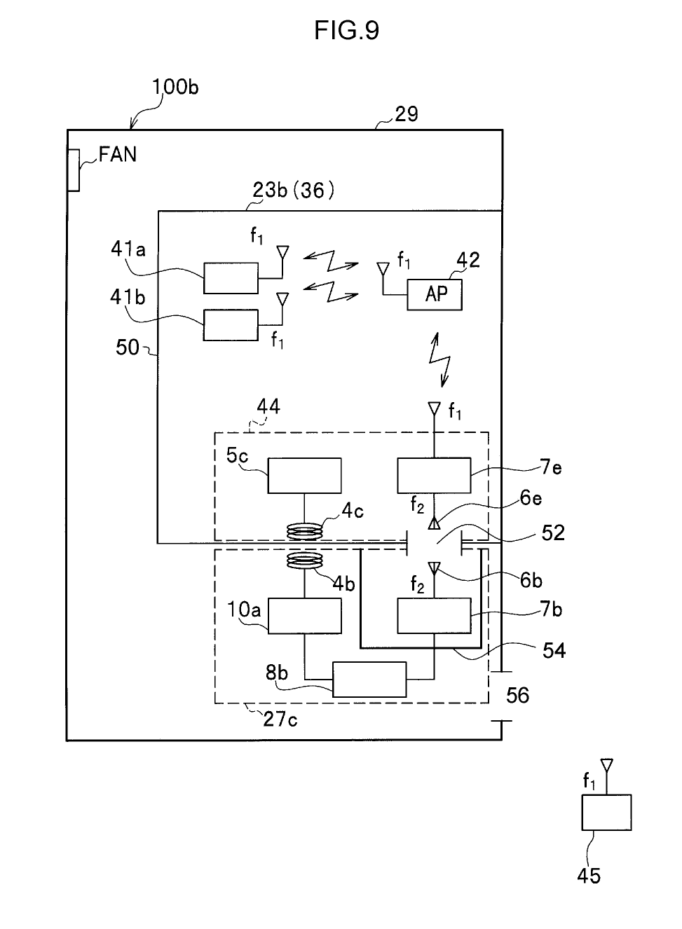

FIG. 9 is a schematic diagram of an ATM according to a fifth embodiment of the present disclosure.

In an automatic transaction device 100b, similarly to the embodiments described above, the banknote deposit and withdrawal section 1, the customer operation and display section 21, the card unit 23, the receipt unit 22, the numberpad section 24, the external shutter 25 and the control device 26 are provided inside the main body casing 29.

However, FIG. 9 differs in depicting a fan and a vent aperture 56 in the main body casing and in depicting an information communication device 45 outside the main body casing 29. The fifth embodiment is below described as an example in which the present disclosure is applied to a card unit 23b. However, the same operational effects are provided in a case of application to a banknote storage vault.

The card unit 23b is provided with, inside a casing 50, plural data carriers 41a and 41b that serve as transceivers incorporating sensors, an access point (AP) 42 that serves as a transceiver, and a communications device with electricity reception function 44. The access point 42 communicates data with the plural data carriers 41a and 41b and the communications device with electricity reception function 44 at, for example, a frequency f1 in the 2.4 GHz band. The communications device with electricity reception function 44 includes a wireless device 7e equipped with an antenna 6e, and an electricity reception circuit 5c equipped with a coil 4c.

The data carriers 41a and 41b have functions for detecting insertion, removal and the like of cards, reading card information, and sending data to the access point 42. In this embodiment, the transceiver frequency f1 falls in the 2.4 GHz band used for wireless LANs. The access point 42 features an electricity transmission function and the data carriers 41a and 41b feature an electricity reception function.

The casing of the card unit 23b is a resin casing plated with metal or vapor-deposited with metal and is provided with an aperture portion 52 between the antenna 6b and the antenna 6e. The casing 50 of the card unit 23b may be a metal casing, in which case aperture portions are provided between the coil 4b and the coil 4c and between the antenna 6b and the antenna 6e: there must be resin plated with metal or vapor-deposited with metal at least between the coil 4b and the coil 4c, and there must be an aperture portion or just resin between the antenna 6b and the antenna 6e. Just resin is not plated with metal or vapor-deposited with metal; nor is an aperture portion plated with metal or vapor-deposited with metal.

Similarly to the embodiments described above, a communications device with electricity transmission function 27c of the automatic transaction device 100b is mounted inside the main body casing 29. The communications device with electricity transmission function 27c is provided with the electricity transmission circuit 10a equipped with the coil 4b, the wireless device 7b equipped with the antenna 6b, and the control circuit 8b. The antenna 6b and wireless device 7b are enclosed by a metal casing 54. An end of this metal casing 54 is disposed close to the casing of the card unit 23b. A frequency of the wireless devices 7b and 7e is f2. The frequency f2 may be equal to f1, and may be different from f1. For example, if the 5 GHz band is used for f2 and f2≠f1, the effects of interference waves do not affect communications between the wireless device 7b and the wireless device 7e.

Between the coil 4b and the coil 4c, electromagnetic waves of tens of kHz must be passed and electromagnetic waves at 2.4 GHz must be blocked. Because a penetration depth for tens of kHz is deep and a penetration depth for 2.4 GHz is shallow, it is possible to pass magnetic fields and electromagnetic waves at tens of kHz and block electromagnetic waves (plane waves) at 2.4 GHz by setting a metal thickness of the metal plating or vapor-deposited metal on the resin casing appropriately.

The penetration depth d is calculated by

d=√(2 ρ/ωμ),

in which ρ represents electrical resistivity of a conductor, μ represents magnetic permeability, and ω represents angular frequency. For example, of aluminium, the electrical resistivity p is 2.65×10⁻⁸ Ω·m and the magnetic permeability μ is 1.000×μ₀=4 π×10⁻⁷ H/m. Thus, at 2.4 GHz,

d=√(2 ρ/ωμ)=5.289 μm.

By comparison, at 100 kHz,

d=√(2 ρ/ωμ)=518 μm.

Thus, an aluminium film thickness is set to 20 to 100 μm, or preferably 40 to 50 μm.

### Description of Operations

Although the main body casing 29 of the automatic transaction device 100b is shielded, the fan and the vent aperture 56 are formed. Thus, interference waves (electromagnetic waves) in the 2.4 GHz band intrude inside the main body casing 29 from the information communication device 45 that is disposed outside the main body casing 29. If the casing of the card unit 23b was simply a resin casing, the intruding interference waves would interfere with communications between the data carriers 41a and 41b and the access point 42. Alternatively, if the casing of the card unit 23b was a metal casing, because the metal casing would be interposed between the coil 4b and the coil 4c and between the antenna 6b and the antenna 6e, magnetic fields and electromagnetic waves would be reflected and it would be difficult to both transmit electricity and communicate data.

Accordingly, the casing of the card unit 23b according to the present embodiment is the casing 50 of resin that is plated with metal or vapor-deposited with metal, and the aperture portion 52 is provided between the antenna 6b and the antenna 6e. Therefore, the casing of the card unit 23b may pass magnetic fields (electromagnetic waves) for electricity transmission at tens of kHz and block interference waves in the 2.4 GHz band. In this embodiment, the aperture sandwiched by the antennas 6b and 6e allows interference waves in the 2.4 GHz band to pass through but, because the aperture portion is smaller in area than the coils 4b and 4c, the effects of interference waves are slight. If the antenna 6b and the wireless device 7b are enclosed by the metal casing 54 as appropriate, the strength of interference waves passing through the aperture portion 52 is reduced.

### Variant Examples

The present disclosure is not limited to the embodiments described above and numerous modifications and improvements may be applied within a scope not departing from the gist of the present disclosure. For example, the following modifications are possible.

In the first embodiment, the coil 4a for electricity transmission is provided at the casing floor face of a banknote storage vault 36, but may be disposed at locations other than the floor face of a casing provided those regions are close to the main body of the automatic transaction device 100. For example, a coil may be disposed at a side face of a casing. Because the antennas of the first embodiment and the second embodiment use higher-frequency electromagnetic waves, they have a greater degree of freedom of location. In the second embodiment, both electricity transmission and data communications are performed at high frequency. However, data communications may be implemented by carrying information in modulations of currents induced by electromagnetic induction. Transmitting information by modulating the signals is also within the scope of the present disclosure for alternative electricity transmission methods such as electric field coupling and the like. Although the embodiments described above assume an automatic transaction device (an ATM) with functions for receiving and paying out cash, the present disclosure also encompasses lockers, vending machines, cash dispensers, ticket-selling machines and the like that include the banknote deposit and withdrawal section 1.

The disclosures of Japanese Patent Application No. 2014-122207 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. An automatic transaction device comprising:
a main body casing inside which a non-contact electricity transmitter and an equipment wireless communications unit that communicates by first electromagnetic waves are mounted; and
a banknote storage vault that is stowable inside the main body casing and removable to outside the main body casing, that stores banknotes, and that includes thereinside:
a non-contact electricity receiver that receives electricity from the non-contact electricity transmitter, and
a storage vault wireless communications unit that is supplied with electricity by the non-contact electricity receiver and that communicates with the equipment wireless communications unit,
wherein, in a stowed state in which the banknote storage vault is stowed inside the main body casing, the non-contact electricity transmitter and the non-contact electricity receiver are in a proximate state.

2. The automatic transaction device according to claim 1 wherein, in a removed state in which the banknote storage vault is removed to outside the main body casing, the non-contact electricity transmitter and the non-contact electricity receiver are in a separated state in which the non-contact electricity transmitter and the non-contact electricity receiver are separated in a removal direction.

3. The automatic transaction device according to claim 2, further comprising a loading frame that changes a position of the banknote storage vault toward inside the main body casing or outside the main body casing, wherein:
a plurality of the banknote storage vault are provided at the loading frame, the plurality of banknote storage vaults being provided along the removal direction,
at least one of the banknote storage vaults has an electric motor that conveys the banknotes, the electric motor supplied with electricity by the non-contact electricity receiver, and
electricity is transmitted to the non-contact electricity receiver of the banknote storage vault having the electric motor using electromagnetic induction from the non-contact electricity transmitter.

4. The automatic transaction device according to claim 3, wherein:
electricity is transmitted, to the other bank storage vaults not having the electric motor, using second electromagnetic waves from an antenna of the non-contact electricity transmitter, the second electromagnetic waves differing in frequency from the first electromagnetic waves used in communicating, and
the equipment wireless communications unit communicates the information using the antenna.

5. The automatic transaction device according to claim 2, further comprising a loading frame that changes a position of the banknote storage vault toward inside the main body casing or outside the main body casing, wherein:
a plurality of banknote storage vaults are provided at the loading frame, the plurality of banknote storage vaults being provided along the removal direction,
each of the banknote storage vaults is supplied with electricity by the non-contact electricity receiver and is provided with an electric motor that conveys the banknotes,
the non-contact electricity transmitter has a first coil and the non-contact electricity receiver has a second coil, and
electricity is transmitted by electromagnetic induction between the first coil and the second coil.

6. The automatic transaction device according to claim 3, wherein:
the non-contact electricity transmitter has a first coil and the non-contact electricity receiver has a second coil,
resin plated with metal or vapor-deposited with metal is formed between the first coil and the second coil,
the equipment wireless communications unit has a first antenna and the storage vault wireless communications unit has a second antenna, and
resin plated with metal or vapor-deposited with metal is not formed between the first antenna and the second antenna.

7. The automatic transaction device according to claim 1 wherein, in the stowed state, proximate surfaces of the banknote storage vault and the main body casing are planar surfaces.

8. The automatic transaction device according to claim 2, further comprising a loading frame that changes a position of the banknote storage vault toward inside the main body casing or outside the main body casing, wherein:
the banknote storage vault is stowed in the loading frame,
the loading frame and the banknote storage vault are provided with first protrusion-recess units that fit with one another and allow the banknote storage vault to slide in a vertical direction, and
the loading frame and the main body casing are provided with second protrusion-recess units that fit with one another and allow sliding of the loading frame in the removal direction.

9. An automatic transaction device comprising:
a main body casing inside which a non-contact electricity transmitter that transmits electricity by electromagnetic induction and an equipment wireless communications unit that communicates by electromagnetic waves are mounted; and
an inner unit including:
a non-contact electricity receiver that receives electricity from the non-contact electricity transmitter, and
a unit wireless communications unit that is supplied with electricity by the non-contact electricity receiver and that communicates with the equipment wireless communications unit,
the inner unit being provided inside the main body casing,
wherein:
the non-contact electricity transmitter has a first coil and the non-contact electricity receiver has a second coil, and
a casing of the unit, at least between the first coil and the second coil is formed of resin that is plated with metal or vapor-deposited with metal.

10. The automatic transaction device according to claim 9, wherein:
the equipment wireless communications unit has a first antenna and the storage vault wireless communications unit has a second antenna,
the casing of the inner unit is formed by a resin casing that is plated with metal or vapor-deposited with metal, and
the casing of the unit is provided with an aperture between the first antenna and the second antenna.

11. The automatic transaction device according to claim 9, wherein the inner unit is a card unit that accesses information recorded in a card, or a receipt processing unit that ejects a receipt.

12. An automatic transaction device comprising:
a main body casing having a first electricity transmission unit that transmits or receives electricity, and a first wireless communications unit that performs wireless communications; and
a banknote storage vault that stores banknotes,
wherein:
the banknote storage vault has a second electricity transmission unit that transmits electricity to the first electricity transmission unit, or receives electricity from the first electricity transmission unit, and a second wireless communications unit that performs wireless communications with the first wireless communications unit, and
the first electricity transmission unit faces the second electricity transmission unit, in a case in which electricity is transmitted between the first electricity transmission unit and the second electricity transmission unit in a non-contact manner.

13. The automatic transaction device according to claim 12, further comprising a removal mechanism that removes the banknote storage vault from inside the main body casing to outside the main body casing.

14. The automatic transaction device according to claim 12, wherein the second electricity transmission unit supplies the second wireless communications unit with electricity.

15. An automatic transaction device comprising:
a main body casing having a first wireless communications unit that performs wireless communications via a first antenna; and
a banknote storage vault that stores banknotes,
wherein:
the banknote storage vault has a second wireless communications unit that performs wireless communications via a second antenna,
the first wireless communications unit and the second wireless communications unit communicates each other in wireless communications between the first antenna and the second antenna by first electromagnetic waves,
the first electricity transmission unit and the second electricity transmission unit transmits or receives electricity by second electromagnetic waves, the second electromagnetic waves differing in frequency from the first electromagnetic waves.

16. An automatic transaction device comprising:
a main body casing having a first coil, and a first wireless communications unit that includes an antenna to perform wireless communications, and
a banknote storage vault that stores banknotes,
wherein:
the banknote storage vault has a second coil, and a second wireless communications unit that performs wireless communications with the first wireless communications unit, and
the first coil faces the second coil in a case in which electricity is transmitted between the first coil and the second coil in a non-contact manner.

17. An automatic transaction device comprising:
a main body casing having a first wireless communications unit that transmits electricity, and that performs wireless communications, and
a banknote storage vault having a second wireless communications unit that transmits electricity, and that performs wireless communications,
wherein:
the second wireless communications unit transmits electricity to the first wireless communications unit, or receives electricity from the first electricity transmission unit, and performs wireless communications with the first wireless communications unit,
the first wireless communications unit faces the second wireless communications unit, in a case in which electricity is transmitted between the first wireless communications unit and the second wireless communications unit in a non-contact manner.
